(19) United States
(12) Patent Application Publication
(10) Pub. No.: US 2025/0180969 A1
(43) Pub. Date: Jun. 5, 2025

(54) CAMERA FIXING DEVICE

(71) Applicant: Hanwha Vision Co., Ltd., Seongnam-si (KR)

(72) Inventor: Jung Uk KU, Seongnam-si (KR)

(73) Assignee: Hanwha Vision Co., Ltd., Seongnam-si (KR)

(21) Appl. No.: 18/960,218

(22) Filed: Nov. 26, 2024

(30) Foreign Application Priority Data
Nov. 30, 2023 (KR) 10-2023-0170941

(51) Int. Cl. G03B 17/56

(52) U.S. Cl. CPC G03B 17/561

(57) ABSTRACT

A camera fixing device may include: a housing configured to be fixed on an installation surface; a cover configured to be coupled to the housing; an extension portion, wherein a first side of the extension portion in a first direction is between the housing and the cover, and a second side of the extension portion in a second direction, opposite to the first direction, extends outwardly from the cover; and a support portion configured to elastically press the first side of the extension portion in the second direction towards the cover from the housing.

### CROSS-REFERENCE TO RELATED APPLICATION

This application claims priority from Korean Patent Application No. 10-2023-0170941, filed on Nov. 30, 2023 in the Korean Intellectual Property Office, and all the benefits accruing therefrom under 35 U.S.C. 119, the disclosure of which in its entirety is herein incorporated by reference.

### BACKGROUND

### 1. Field

Embodiments of the present disclosure relate to a camera fixing device and, more particularly, to a camera fixing device in which a camera is installed on an extension portion that extends from a camera mounting area to prevent deformation in a camera installation structure from external impact.

### 2. Description of Related Art

Generally, surveillance cameras for monitoring specific areas may be equipped with multiple camera modules that support pan, tilt, and zoom movements to cover a wide area with a smaller number of devices and to track objects with specific movements. Among various types of surveillance cameras, dome cameras, in particular, are increasingly being used due to their circular symmetric shape about a central axis, which facilitates pan, tilt, and zoom movements and allows for miniaturization.

Such a surveillance camera may include a dome cover designed to enclose multiple cameras with a transparent optical exterior component. Air may be directed toward an inner surface of the dome cover by a fan installed inside the dome cover, preventing blurring or condensation on the dome cover. Specifically, a dome camera may be equipped with multiple blower fans, intake ports, and exhaust ports positioned near multiple camera modules arranged along a circumference of the housing.

Additionally, when a surveillance camera is installed in a location with a high ceilings, such as a factory or library, an extension portion extending from the installation surface can position the camera closer to the monitored area.

However, in such a surveillance camera, if an impact is applied to the extension portion extending from the installation surface toward the monitored area, a bracket securing the extension portion can deform, making it difficult to maintain the fixed installation position of the camera.

### SUMMARY

According to embodiments of the present disclosure, a camera fixing device may be provided in which a camera is installed on an extension portion that extends from a camera mounting area to prevent deformation in a camera installation structure from external impact.

According to embodiments of the present disclosure, a camera fixing device may be provided and include: a housing configured to be fixed on an installation surface; a cover configured to be coupled to the housing; an extension portion, wherein a first side of the extension portion in a first direction is between the housing and the cover, and a second side of the extension portion in a second direction, opposite to the first direction, extends outwardly from the cover; and a support portion configured to elastically press the first side of the extension portion in the second direction towards the cover from the housing.

According to embodiments of the present disclosure, a fixing device may be provided and include: a housing configured to be fixed on an installation surface; a cover configured to be coupled to the housing; an extension portion, wherein a first side of the extension portion in a first direction is between the housing and the cover, and a second side of the extension portion in a second direction, opposite to the first direction, is outside of the cover in the second direction; and a support portion configured to elastically press the first side of the extension portion in the second direction towards the cover from the housing.

According to embodiments of the present disclosure, a method of assembling a camera fixing device may be provided and include: coupling a housing of the camera fixing device to an installation surface; and coupling a cover of the camera fixing device to the housing while at least a part of an extension portion of the camera fixing device and a support portion of the camera fixing device is between the cover and the housing, wherein a first side of the extension portion in a first direction is between the housing and the cover, and a second side of the extension portion in a second direction, opposite to the first direction, extends outwardly from the cover, and wherein the support portion is configured to elastically press the first side of the extension portion in the second direction towards the cover from the housing.

A camera fixing device according to embodiments of the present disclosure may provide the following advantages.

First, since the extension portion is disposed to be pivotable between the housing and the cover, deformation or damage due to external impact can be prevented.

Second, as the support portion inside the housing and cover absorbs external impact, the conventional issue of bracket deformation between the housing and the cover can be addressed.

Third, by resolving this and other conventional issues, the deterioration of commercial value during the repetitive disassembly and assembly processes of the camera fixing device can be prevented.

It should be noted that aspects and effects of embodiments of the present disclosure are not limited to those described above, and other aspects and effects of embodiments of the present disclosure will be apparent to one of ordinary skill in the art to which the present disclosure pertains by referencing the detailed description of the present disclosure given below.

### BRIEF DESCRIPTION OF DRAWINGS

The detailed description of non-limiting example embodiments of the present disclosure described below, as well as the summary described above, will be better understood when read in conjunction with the accompanying drawings. The drawings illustrate example embodiments of the present disclosure for illustrative purposes. However, it should be understood that the present disclosure is not limited to the exact arrangements and means shown in the drawings.

FIG. 1 is a reference diagram illustrating a space where a camera fixing device, according to an embodiment of the present disclosure, is installed.

FIG. 2 is a reference diagram illustrating a state in which the camera fixing device of FIG. 1 rotates due to an external impact.

FIG. 3 is a front view of the camera fixing device of FIG. 1.

FIG. 4 is a longitudinal cross-sectional view illustrating a state of the camera fixing device of FIG. 3 when an external impact is yet to be applied.

FIG. 5 is an exploded perspective view illustrating the camera fixing device of FIG. 4.

FIG. 6 is a longitudinal cross-sectional view illustrating a state of the camera fixing device of FIG. 4 when an external impact is applied.

FIG. 7 is a perspective view illustrating the camera fixing device of FIG. 2.

FIG. 8 is a cross-sectional view illustrating a state where the housing of the camera fixing device of FIG. 7 is partially opened.

FIG. 9 is a longitudinal cross-sectional view of the camera fixing device along a line A-A′ of FIG. 7.

### DETAILED DESCRIPTION

Non-limiting example embodiments of the present disclosure will hereinafter be described in detail with reference to the accompanying drawings. Advantages, features, and methods for achieving the same in the present disclosure will become apparent by referring to the example embodiments described below along with the accompanying drawings. However, embodiments of the present disclosure are not limited to the example embodiments set forth below and may be implemented in various other forms. The following example embodiments are provided to make the present disclosure complete and to fully convey the scope of the present disclosure to those skilled in the art. Throughout the specification, the same reference numerals denote the same components.

Embodiments of the present disclosure can undergo various modifications, and non-limiting example embodiments of the present disclosure are illustrated in the drawings. However, the example embodiments that are described and illustrated are not intended to limit the present disclosure to such specific embodiments, and it should be understood that all modifications, equivalents, and alternatives are within the spirit and scope of the present disclosure.

Terms including ordinal numbers such as “first,” “second,” etc., may be used to describe various components, but these components are not limited by these terms. These terms are used only to distinguish one component from another. For example, a second component can be named a first component without departing from the scope of the present disclosure, and similarly, a first component can be named a second component.

The term “and/or” includes any combination of one or more of the associated listed items or any of the listed items individually.

When a component is said to be “connected to” or “coupled to” another component, it may be directly connected or coupled to the other component, or intervening components may be present. Conversely, when a component is said to be “directly connected to” or “directly coupled to” another component, there are no intervening components.

The terms used in this application are for the purpose of describing example embodiments only and are not intended to limit the scope of the present disclosure.

Unless the context clearly indicates otherwise, the singular forms include the plural forms as well.

In this application, the terms “comprising,” “including,” or “having” are intended to specify the presence of stated features, numbers, steps, operations, elements, components, or combinations thereof, but do not preclude the presence or addition of one or more other features, numbers, steps, operations, elements, components, or combinations thereof.

Non-limiting example embodiments of the present disclosure will hereinafter be described with reference to the accompanying drawings, wherein the same or corresponding components, regardless of the drawing figure numbers, are assigned the same reference numbers, and redundant descriptions may be omitted.

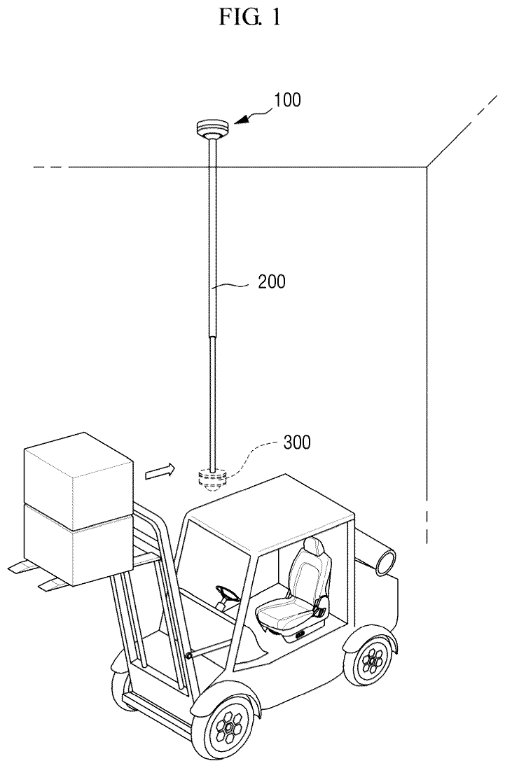

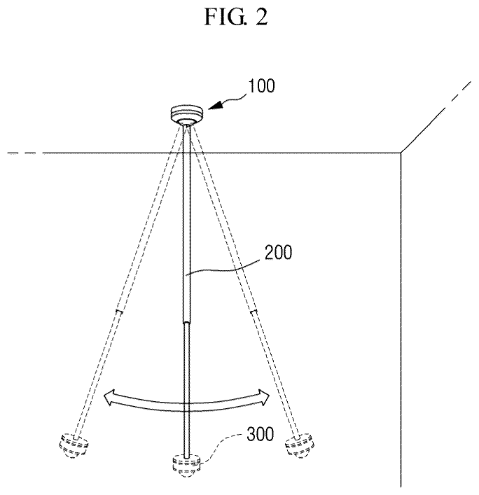

FIG. 1 is a reference diagram illustrating a space where a camera fixing device according to an embodiment of the present disclosure is installed, and FIG. 2 is a reference diagram illustrating a state in which the camera fixing device of FIG. 1 rotates due to an external impact.

Referring to FIGS. 1 and 2, a camera fixing device 100 may be installed at a lowered height in a high-ceilinged space, such as a factory or library, to place a surveillance camera closer to a monitoring area.

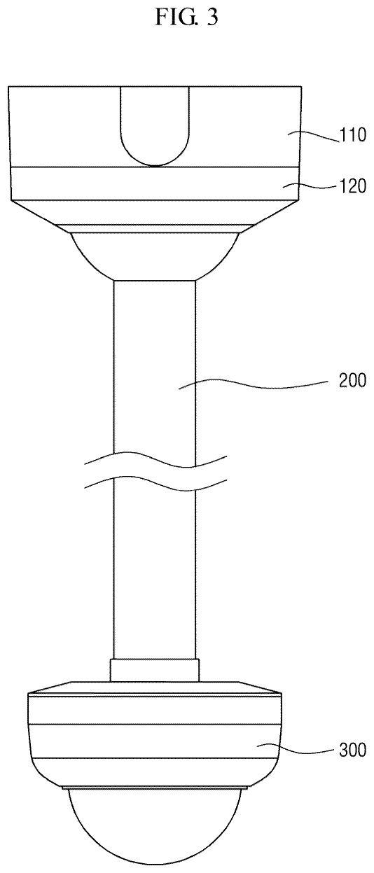

The camera fixing device 100 may include an assembly where a housing 110 (see FIG. 3) and a cover 120 (see FIG. 3) are combined, and an extension portion 200 which extends downward from the assembly. A camera module 300 may be installed at the lower end of the extension portion 200.

The camera module 300 may be installed in a suspended structure from the installation surface via the extension portion 200. For example, the camera module 300 may come into contact with a top of a tall work vehicle or a load carried on the work vehicle within a workspace. In this case, the camera module 300 may be configured to pivot on the assembly when colliding with the work vehicle.

Thus, the camera fixing device 100 can prevent the camera module 300 from being damaged when it comes into contact with the work vehicle and can also prevent deformation in the connection between the extension portion 200 and the assembly from deforming.

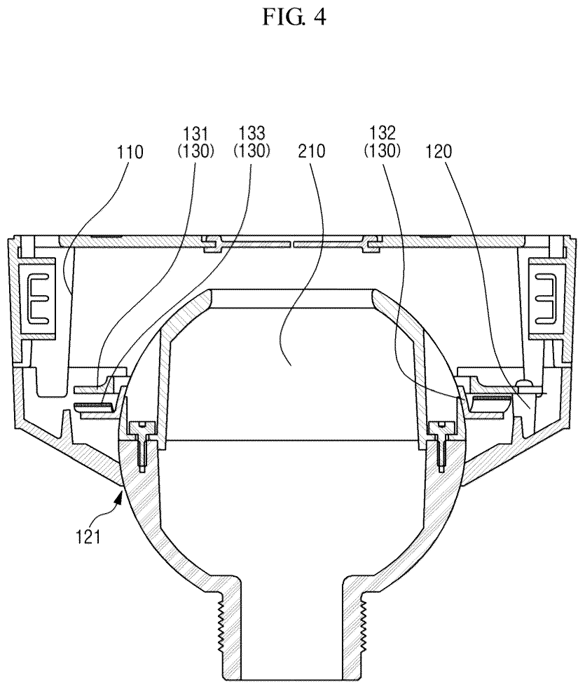

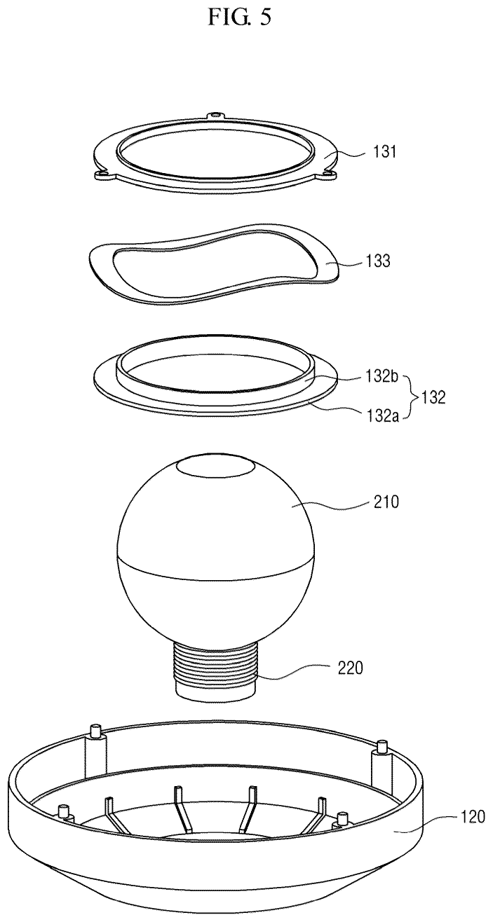

FIG. 3 is a front view of the camera fixing device of FIG. 1, FIG. 4 is a longitudinal cross-sectional view illustrating the state of the camera fixing device of FIG. 3 when an external impact is yet to be applied, and FIG. 5 is an exploded perspective view illustrating the camera fixing device of FIG. 4.

Referring to FIGS. 3 through 5, the camera fixing device 100 may include the housing 110, the cover 120, the extension portion 200, and a support portion 130.

The housing 110 may be fixed to the installation surface. Here, the installation surface may be formed on the bottom of a ceiling, a column, or a beam. According to embodiments, the housing 110 may also be mounted on a separate structure protruding from the sidewall.

Additionally, the cover 120 may be coupled to cover the bottom of the housing 110. The cover 120 may be disposed to face the housing 110 and may be sized to correspond to the diameter or cross-sectional area of the housing 110.

At the center of the cover 120, a fastening hole 121 may be formed to partially insert the extension portion 200. The cover 120 may provide the function of coupling the extension portion 200 to be closely positioned within the housing 110.

Moreover, the extension portion 200 may include a ball member 210 at one side thereof and a pole member 220 extending at the other side thereof, where the camera module 300 is installed.

The extension portion 200 may be supported such that the ball member 210 may be interposed between the housing 110 and the cover 120, allowing the ball member 210 to pivot between the housing 110 and the cover 120. Thus, even if an external force impacts the camera module 300, the ball member 210 on one side of the extension portion 200 pivots, preventing damage.

The support portion 130 may include a fixing member 131, a contact member 132, and a wave washer 133.

The fixing member 131 may be fixedly installed within the housing 110. The fixing member 131 may be configured to protrude toward the ball member 210 from inside the housing 110. Alternatively, the fixing member 131 may be integrally formed with the housing 110.

Additionally, the contact member 132 may be disposed to face the fixing member 131 and may be elastically positioned away from the fixing member 131 around the wave washer 133.

The contact member 132 may include a support piece 132a and a contact piece 132b.

The support piece 132a may support the wave washer 133, facing the fixing member 131. In other words, the elastic restoring force provided by the wave washer 133 between the fixing member 131 and the contact member 132 may be transmitted in the direction of the support piece 132a.

The contact piece 132b may be bent inside the support piece 132a to be disposed to contact the outer surface of the ball member 210. According to embodiments, the contact piece 132b may be formed as a curved surface corresponding to the outer surface curvature of the ball member 210.

The contact member 132 may be coupled to the fixing member 131 or may simply be spaced apart from the fixing member 131.

The wave washer 133 may be formed with a plurality of wave patterns that vary in height. That is, the wave washer 133 may vary in height between the fixing member 131 and contact member 132. The wave washer 133 may absorb impact between the fixing member 131 and the contact member 132 as its height changes. Alternatively, the wave washer 133 may minimize the impact from the contact member 132 to the fixing member 131. At this time, the contact member 132 may be disposed to elastically approach or recede from the fixing member 131 around the wave washer 133.

Additionally, the contact piece 132b may be configured to contact a portion of the ball member 210 between an upper end of the ball member and a center portion of the ball member 210, wherein the center portion may define a diameter of the ball member 210 in a horizontal direction. Also, the fastening hole 121 in the cover 120 may be configured to contact a portion of the ball member 210 between a lower end of the ball member 210 and the center portion of the ball member 210.

For example, according to embodiments, the wave washer 133 may adjust the degree of pendulum-like rotation in the extension portion 200 due to external impact, depending on its thickness, material, and wave height. That is, when the wave washer 133 is relatively thicker or formed of a material with a stronger elastic restoring force, the fixing force pressing the ball member 210 increases, allowing it to rotate on the cover 120 with a slower or tighter feel. Therefore, the type of wave washer 133 can be selectively applied based on its intended position or purpose.

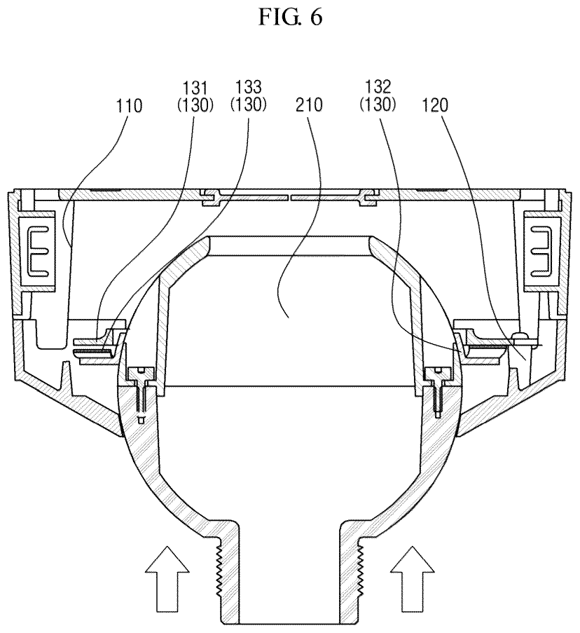

FIG. 6 is a longitudinal cross-sectional view illustrating a state of the camera fixing device of FIG. 4 when an external impact is applied.

Referring to FIG. 6, when impact is transmitted to the extension portion 200, the ball member 210 may press against the contact member 132, and the wave washer 133 compresses, minimizing impact transfer in the direction of the fixing member 131.

For example, if impact is transmitted to the camera module 300, the impact may be conveyed through the extension portion 200, causing the ball member 210 to pivot. Additionally, prior to or during pivoting, the impact is transmitted to the contact member 132. In this case, the wave washer 133 can absorb at least some of the impact transmitted to the contact member 132 instead of passing it onto the fixing member 131, thereby minimizing impact transfer to the housing 110 or the cover 120.

The support portion 130 may provide elastic restoring force to ensure that the ball member 210 is continuously pressed in the direction of the fastening hole 121 in the cover 120. Therefore, even when the impact on the extension portion 200 is released, the extension portion 200 can still pivot within a set range without breaking, maintaining the coupled state of the housing 110 and cover 120.

Furthermore, the support portion 130 may prevent deformation when the camera fixing device 100 is repositioned from its original installation location or repeatedly assembled and disassembled for maintenance. Since the support portion 130 elastically supports the extension portion 200, it effectively prevents the deterioration of commercial value due to external impact.

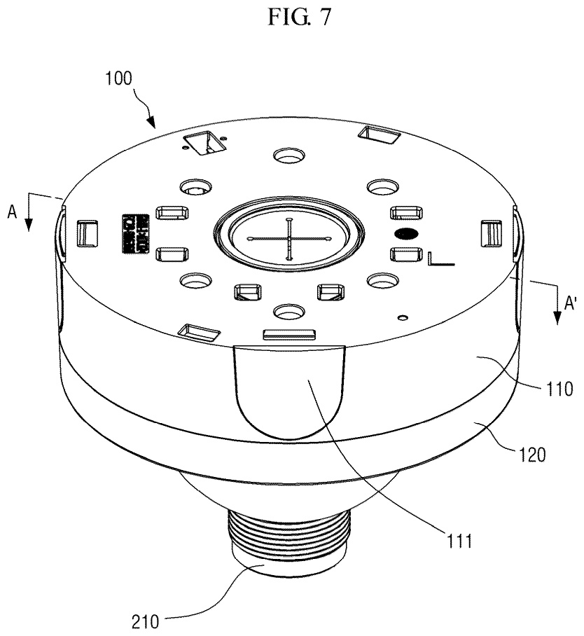

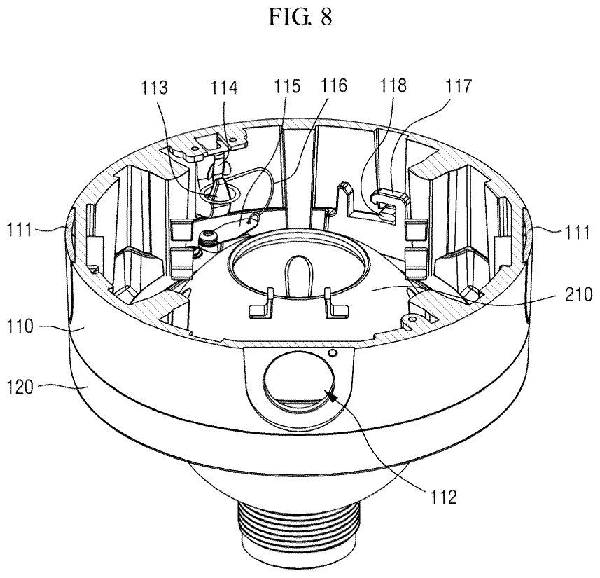

FIG. 7 is a perspective view illustrating the camera fixing device of FIG. 2, and FIG. 8 is a cross-sectional view illustrating a state where the housing of the camera fixing device of FIG. 7 is partially opened.

Referring to FIGS. 7 and 8, the camera fixing device 100 may include a plurality of caps 111 arranged along a circumferential direction.

Three caps 111 may be provided in a perpendicular direction along the circumference of the housing 110. The caps 111 may be detachably coupled to the outer circumferential surface of the housing 110.

As illustrated in FIG. 8, through-holes 112 may be formed on the housing 110 to communicate with the interior of the housing 110. The through-holes 112 may be exposed when the caps 111 are removed from the housing 110, respectively. Pipes to which the power lines or control lines of the camera module 300 are connected may be connected through the through-holes 112.

Accordingly, the housing 110 may have its installation direction set based on the connection direction of each pipe, and even after installation is complete, additional pipes may be connected by removing other ones of the caps 111.

According to embodiments, additional sealing members for dustproofing or moisture-proofing purposes may be provided between the through-holes 112 and the pipes.

The housing 110 may also include a first hook member 113, an interference member 114, and a wire 116.

The first hook member 113 may protrude from an inner circumferential surface of the housing 110 and be arranged to bend upward. According to embodiments of the present disclosure, the first hook member 113 may have a shape of a hook.

The interference member 114 may be configured to elastically contact an upper part of the first hook member 113.

The wire 116 may provide a safety wire function that maintains the housing 110 and the cover 120 from falling apart, while being spaced apart by more than the length of the wire 116, even if they become separated.

One side of the wire 116 may be disposed to wind around the first hook member 113, while the other side of the wire 116 may be connected to a clip 115 attached to the cover 120.

The interference member 114 may generally be disposed to contact the tip of the first hook member 113 to prevent one side of the wire 116 from becoming detached from the first hook member 113. When connecting or disconnecting the wire 116 to or from the first hook member 113, the interference member 114 may be elastically deformed to form a predetermined gap from the tip of the first hook member 113.

The first hook member 113 and the clip 115 may be disposed parallel to each other in the vertical direction.

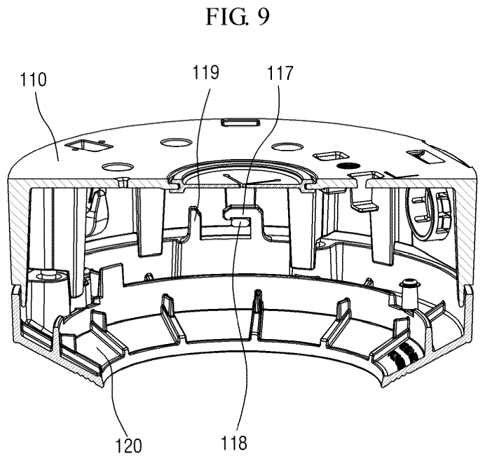

FIG. 9 is a longitudinal cross-sectional view of the camera fixing device along a line A-A′ of FIG. 7.

Referring to FIG. 9, the housing 110 may include a protruding member 118. The protruding member 118 may protrude perpendicularly from the inner circumferential surface of the housing 110.

Additionally, the cover 120 may have a second hook member 117 positioned to correspond to the location of the protruding member 118. The second hook member 117 may be used to temporarily couple the housing 110 and the cover 120 while being coupled to interfere with the top surface of the protruding member 118. According to embodiments of the present disclosure, the second hook member 117 may have a shape of a hook.

The cover 120 may also include a guide member 119 disposed adjacent to the second hook member 117. A gap may be formed between the tips of the guide member 119 and the second hook member 117 to allow the protruding member 118 to be inserted. Here, the tip of the guide member 119 may be formed as an inclined surface facing the tip of the second hook member 117, making it easier to guide the insertion of the protruding member 118 between the second hook member 117 and the guide member 119.

Therefore, a plurality of the protruding member 118 and the second hook member 117 may each be disposed in multiple areas along the inner circumferential surfaces of the housing 110 and the cover 120. FIG. 9 illustrates that the cover 120 and the housing 110 are separated by a predetermined gap corresponding to the height of the second hook member 117.

For example, the camera module 300 of FIG. 3 may be coupled to the cover 120 along with the extension portion 200. By temporarily securing the cover 120 and the housing 110 by first using the protruding member 118 and the second hook member 117 with the cover 120, the extension portion 200, and the camera module 300 all connected, assembly and maintenance efficiency can be improved.

Thus, according to the camera fixing device of embodiments of the present disclosure, the extension portion may be positioned to be pivotable between the housing and the cover, preventing deformation or damage from external impact. The support portion within the housing and cover may absorb external impact, resolving the conventional problem of bracket deformation between the housing and the cover. By addressing this and other conventional issues, the camera fixing device may prevent the deterioration of commercial value during repetitive disassembly and assembly processes.

While non-limiting example embodiments of the present disclosure have been described above in connection with the accompanying drawings, embodiments of the present disclosure are not limited to the specific configurations and operations of these embodiments. Various modifications can be made without departing from the spirit and scope of embodiments of the present disclosure. Therefore, such modifications should be considered within the scope of the present disclosure.

What is claimed is:

1. A camera fixing device comprising:
a housing configured to be fixed on an installation surface;
a cover configured to be coupled to the housing;
an extension portion, wherein a first side of the extension portion in a first direction is between the housing and the cover, and a second side of the extension portion in a second direction, opposite to the first direction, extends outwardly from the cover; and
a support portion configured to elastically press the first side of the extension portion in the second direction towards the cover from the housing.

2. The camera fixing device of claim 1, wherein the support portion comprises:
a fixing member fixed within the housing;
a contact member configured to contact a ball member of the extension portion, the ball member being at the first side of the extension portion; and
a wave washer between the fixing member and the contact member.

3. The camera fixing device of claim 2, wherein the contact member is configured to elastically approach or recede from the fixing member around the wave washer.

4. The camera fixing device of claim 2, wherein the contact member comprises:
a support piece supporting the wave washer while facing the fixing member; and
a contact piece bent inside the support piece to contact an outer surface of the ball member.

5. The camera fixing device of claim 4, wherein the contact piece contacts a portion of the ball member that is between an upper end of the ball member and a center portion of the ball member, and
wherein the center portion defines a diameter of the ball member.

6. The camera fixing device of claim 4, further comprising a camera module on the second side of the extension portion.

7. The camera fixing device of claim 1, wherein the housing comprises:
through-holes that penetrate an outer circumferential surface of the housing; and
caps configured to be detachably coupled to cover the through-holes.

8. The camera fixing device of claim 1, wherein the housing comprises:
a first hook member protruding from an inner circumferential surface of the housing;
an interference member configured to elastically contact a tip of the first hook member;
a clip coupled to the cover; and
a wire connecting the clip and the first hook member.

9. The camera fixing device of claim 1, wherein the housing comprises a protruding member protruding perpendicularly from an inner circumferential surface of the housing.

10. The camera fixing device of claim 9, wherein the cover comprises:
a second hook member configured to contact the protruding member; and
a guide member adjacent to and spaced apart from the second hook member, the guide member configured to guide the protruding member in a direction towards the second hook member, and
wherein the cover and the housing are configured to be coupled in a state where the protruding member is in the second hook member, spaced apart from the second hook member.

11. The camera fixing device of claim 10, wherein the protruding member is configured to temporarily couple the cover and the housing by contacting the second hook member.

12. A fixing device comprising:
a housing configured to be fixed on an installation surface;
a cover configured to be coupled to the housing;
an extension portion, wherein a first side of the extension portion in a first direction is between the housing and the cover, and a second side of the extension portion in a second direction, opposite to the first direction, is outside of the cover in the second direction; and
a support portion configured to elastically press the first side of the extension portion in the second direction towards the cover from the housing.

13. The fixing device of claim 12, wherein the support portion comprises:
a fixing member fixed within the housing;
a contact member configured to contact a ball member of the extension portion, the ball member being at the first side of the extension portion; and
a wave washer between the fixing member and the contact member.

14. The fixing device of claim 13, wherein the contact member is configured to elastically approach or recede from the fixing member around the wave washer.

15. The fixing device of claim 14, wherein the contact member comprises:
a support piece supporting the wave washer while facing the fixing member; and
a contact piece bent inside the support piece to contact an outer surface of the ball member.

16. A method of assembling a camera fixing device, the method comprising:
coupling a housing of the camera fixing device to an installation surface; and
coupling a cover of the camera fixing device to the housing while at least a part of an extension portion of the camera fixing device and a support portion of the camera fixing device is between the cover and the housing,
wherein a first side of the extension portion in a first direction is between the housing and the cover, and a second side of the extension portion in a second direction, opposite to the first direction, extends outwardly from the cover, and
wherein the support portion is configured to elastically press the first side of the extension portion in the second direction towards the cover from the housing.

17. The method of claim 16, wherein the support portion includes:
a fixing member fixed within the housing;
a contact member configured to contact a ball member of the extension portion, the ball member being at the first side of the extension portion; and
a wave washer between the fixing member and the contact member.

18. The method of claim 17, wherein the contact member is configured to elastically approach or recede from the fixing member around the wave washer.

19. The method of claim 17, wherein the contact member comprises:
a support piece supporting the wave washer while facing the fixing member; and
a contact piece bent inside the support piece to contact an outer surface of the ball member.

20. The method of claim 19, wherein the contact piece contacts a portion of the ball member that is between an upper end of the ball member and a center portion of the ball member, and
wherein the center portion defines a diameter of the ball member.
